(19) United States
(12) Patent Application Publication
(10) Pub. No.: US 2025/0031897 A1
(43) Pub. Date: Jan. 30, 2025

(54) COFFEE MACHINE FOR PREPARING COFFEE WITH HIGHLY FLEXIBLE USE

(71) Applicant: DE' LONGHI APPLIANCES S.r.l., Treviso (IT)

(72) Inventors: Giovanni ROSSETTO, Treviso (IT); Alessio VAZZOLER, Treviso (IT)

(73) Assignee: DE' LONGHI APPLIANCES S.r.l., Treviso (IT)

(21) Appl. No.: 18/713,133

(22) PCT Filed: Nov. 21, 2022
(86) PCT No.: PCT/EP2022/082626

§ 371 Date: May 23, 2024

(30) Foreign Application Priority Data
Dec. 23, 2021 (IT) 102021000032600

(51) Int. Cl. A47J 31/46; A47J 31/06; A47J 31/36; A47J 31/44; A47J 31/54

(52) U.S. Cl. CPC A47J 31/469; A47J 31/0663; A47J 31/3671; A47J 31/4489; A47J 31/461; A47J 31/468; A47J 31/54

(57) ABSTRACT

A coffee machine comprises a water supply pump, a first water heating boiler, a brewing unit comprising a hot water dispensing head, a first hydraulic connection line for connecting said first boiler to said dispensing head, a second by-pass line of the first boiler, hydraulically connecting said pump to said dispensing head, distribution valve means switchable between a first connection configuration of said supply pump to said first line and a second connection configuration of said supply pump to said second line, the first line being provided with a first non-return valve calibrated at a first opening pressure and the second line being provided with a second non-return valve calibrated at a second opening pressure lower than the first opening pressure.

### CROSS-REFERENCE TO RELATED APPLICATIONS

This is a U.S. National Phase Application under 35 U.S.C. 371 of International Patent Application No. PCT/EP2022/082626, filed Nov. 21, 2022, which claims benefit of priority to Italian Patent Application No. 102021000032600, filed Dec. 23, 2021. The entire contents of these applications are hereby incorporated by reference.

### FIELD OF THE INVENTION

The present invention relates to a coffee machine for preparing coffee with highly flexible use. Different technical solutions are known for producing cold coffee based beverages.

### BACKGROUND

In some cases, with machines intended for preparing espresso coffee, the coffee is initially extracted at high pressure at a temperature greater than 50° C., and subsequently the beverage is cooled in the fridge or by adding ice.

This type of extraction produces a beverage in the cup with an aromatic profile similar to hot extraction with the typical notes of espresso coffee which are not very well suited to a cold taste unless sugar is added for compensating the strong bitter flavors.

More recently, extractions have been proposed directly at room temperature and/or low temperatures (e.g., in the range from 0° C. to 25° C.) so as to accelerate the preparation of the beverage which is already cold directly in the cup.

These extractions can be carried out with an espresso coffee machine by deactivating or excluding the boiler that heats the brewing water by a relevant hydraulic by-pass line.

These cold extractions can significantly alter the sensory profile of the extract to the extent that they make it less pleasant because of the presence of bitter/metallic aromas in the mouth.

Finally, such cold extractions may make the quality of the extraction less optimal as they are affected by the effective temperature of the water used and the effective room temperature inside and outside the coffee machine which can vary and not therefore be completely under control.

DE 10 2013 109619 A1 discloses a coffee machine according to the preamble of claim 1.

### SUMMARY

The technical task of the present invention is, therefore, to realize a coffee machine which obviates the above-described technical drawbacks of the prior art.

Within the context of this technical task an object of the invention is to realize a coffee machine configured to guarantee improved cold extraction of the coffee to produce an improved cold extract in terms of body, balance of the aromatic profile and pleasant taste, while respecting the expectations of freshness during tasting.

The technical task, as well as these and other objects, according to the present invention, are reached by realizing a coffee machine comprising a water supply pump, a first water heating boiler, a brewing unit comprising a hot water dispensing head, a first hydraulic connection line for connecting said first boiler to said dispensing head, a second by-pass line of the first boiler, hydraulically connecting said pump to said dispensing head, distribution valve means switchable between a first connection configuration of said supply pump to said first line and a second connection configuration of said supply pump to said second line, characterized in that said first line is provided with a first non-return valve calibrated at a first opening pressure and said second line is provided with a second non-return valve calibrated at a second opening pressure lower than said first opening pressure.

Preferably, said brewing unit comprises a filter holder housing a filter engageable with said dispensing head for delimiting a brewing chamber.

Preferably, said supply pump is configured to dispense water at a dispensing pressure comprised between 4 bar and 25 bar, said first non-return valve is calibrated with a first opening pressure comprised between 3 bar and 8 bar and said second non-return valve is calibrated with a second opening pressure comprised between 0.05 bar and 3 bar.

Preferably, said first non-return valve is calibrated with a first opening pressure comprised between 4 bar and 6 bar and said second non-return valve is calibrated with a second opening pressure comprised between 0.1 bar and 2.5 bar.

The coffee machine comprising a water tank and/or a connection to a water supply, and according to a particularly advantageous aspect has along said second line or upstream of said distribution valve means a thermal stabilizer of the water coming from said water tank and/or from said connection to a water supply.

Preferably said thermal stabilizer is configured to stabilize the temperature of the water coming from said water tank and/or from said connection to a water supply in a range comprised between 25° C. and 35° C.

According to a particularly advantageous aspect said filter holder houses an espresso coffee filter.

In particular, said espresso coffee filter is configured with holes calibrated to maintain a brewing pressure comprised between 6 bar and 15 bar inside said brewing chamber.

In an embodiment of the invention said distribution valve means comprises a three-way solenoid valve.

In an embodiment of the invention, the coffee machine comprises a steam lance and a steam line connected to said first hydraulic line or to a second boiler positioned along a third hydraulic line connected to said supply pump upstream of said first boiler.

The present invention relates to a method for extracting coffee with such a coffee machine, where the cold extraction of coffee is performed at a greater brewing rate than envisaged for cold extraction of espresso coffee through the switching of said distribution valve means to said second connection configuration.

The first boiler is activated for the preparation of hot espresso coffee.

The thermal stabilizer can also be activated for preparing hot espresso coffee and collaborating with the first boiler if placed upstream of said distribution valve means.

The thermal stabilizer is activated for preparing cold espresso coffee both in the case in which it is placed along said second line and in the case in which it is placed upstream of said distribution valve means.

Therefore, according to the invention the cold extraction aims to raise the brewing pressure inside the brewing chamber to compensate for the low extraction temperature.

The cold extraction can take place quickly, with comparable times to those required for preparing a traditional espresso coffee.

In this way there will be three effects:
a) the cold extract of coffee in the cup can maintain a body typical of hot espressos that normally have TDS (Total Dissolved Solids) between 4.5 and 6.5 and which, even if lower, with the same dose reaches TDS between 2.5 and 4, having decisively more body than other cold beverages such as Cold Brew which generally has TDS between 1.3 and 1.4;
b) the creaminess will be greater thanks to the natural nitrogen infusing which comes from the emulsion with air inside the filter holder which, especially in the event of using the pressurized filter with a single calibrated hole comprised between 0.2 and 0.5 mm, makes the cold coffee exit at high speed through the calibrated hole promoting extra foaming in the bottom of the filter holder before distribution into the cup;
c) the aromatic profile will be different as extraction comprised between 25 and 35° C. limits the extraction of the bitter aromas typical of dark roasts and also the extraction of the too acidic aromas of very light roasts, thus guaranteeing a decisively sweeter extraction with respect to the equivalent hot extraction without altering the amount of coffee, roasting, dose or particle size.

It clearly appears that the desired result is obtained due to the fact that, as the second non-return valve is calibrated with a very low opening pressure, a significant part of the pressure dispensed by the supply pump is to be found inside the brewing chamber.

In synergy, the relevant espresso coffee filter helps to maintain the brewing pressure inside the brewing chamber thanks to its appropriately calibrated holes.

It must be underlined that the aforesaid hydraulic circuit can be implemented in an espresso coffee machine in which the cold extraction can be performed with a higher brewing pressure inside the brewing chamber than that envisaged for the hot extraction of espresso coffee.

Therefore, according to the invention, a cold coffee extract is obtained which is visibly similar to an espresso coffee as it has a nice cream which, although lighter, is persistent and at the same time, without altering the amount of coffee used, returns sweeter and less bitter sensory tones with respect to a hot extraction of an espresso coffee.

The use of distribution valve means also enables the switching from hot extraction to cold extraction immediately without first having to cool the first boiler or hot parts of the hydraulic circuit associated therewith which could be warm because of the various thermal inertia values especially if the cold extraction immediately follows a hot extraction.

### BRIEF DESCRIPTION OF THE DRAWINGS

Further features and advantages of the invention will more fully emerge from description of a preferred, but not exclusive, embodiment thereof, according to the invention by way of non-limiting example in the drawings in which:

FIG. 1 schematically shows the hydraulic circuit of the machine in accordance with a first preferred embodiment;

FIG. 2 schematically shows the hydraulic circuit of the machine in accordance with a second preferred embodiment;

FIG. 3 schematically shows the hydraulic circuit of the machine in accordance with a third preferred embodiment;

FIG. 4a shows a first filter solution, illustrated in a sectional lateral raised view along a diameter;

FIG. 4b shows a plan view from below of the filter of FIG. 4a;

FIG. 5a shows a second filter solution, illustrated in a sectional lateral raised view along a diameter; and

FIG. 5b shows a plan view from below of the filter of FIG. 5a.

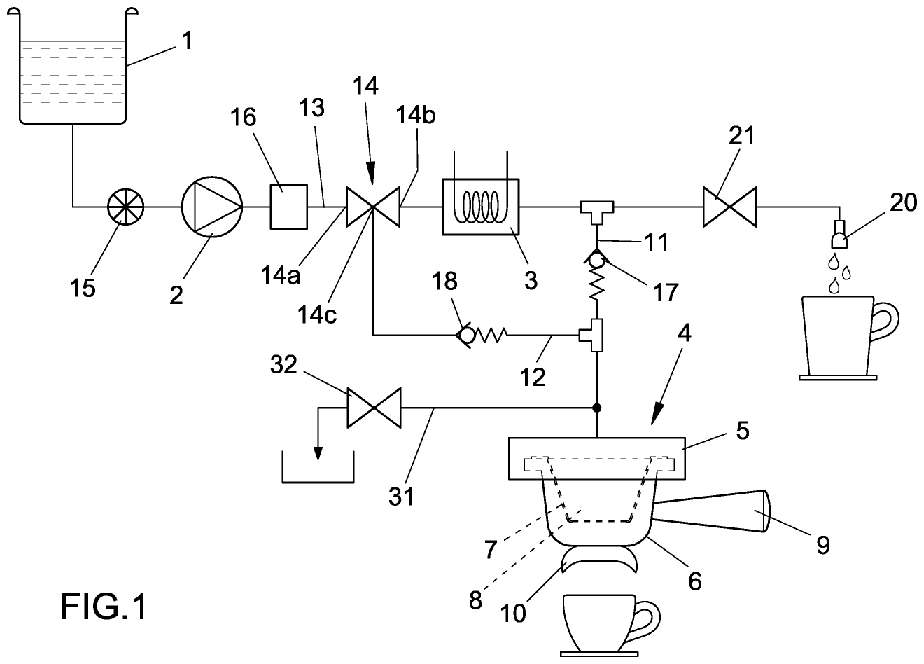

### DETAILED DESCRIPTION

In the following description equivalent parts of the various embodiments of the invention will be indicated with the same reference number.

With reference to the mentioned figures, the hydraulic circuit of the coffee machine is shown comprising a water tank 1 and/or a connection (not illustrated in the specific case) to a water supply, a water supply pump 2 connected in cascade to the water tank 1, a first water heating boiler 3 connected in cascade to the pump 1, a brewing unit 4 connected in cascade to the boiler 3 and comprising a hot water dispensing head 5.

The brewing unit 4 further comprises a filter holder 6 housing a filter 7 engageable with the dispensing head 5 for delimiting a brewing chamber 8.

The filter holder 6 has in a known way a hand grip 9 and one or more dispensing spouts 10, as well as relevant removable engagement means (not shown) with the dispensing head 5, for example, but not necessarily, outer perimeter wings of the filter holder 6 which can be coupled into corresponding seats (not shown) provided in the dispensing head 5.

The coupling of the wings into the corresponding seats can be carried out manually by a rotary or translational movement of the filter holder 6 with respect to the dispensing head 5.

The hydraulic circuit comprises a first hydraulic connection line 11 for connecting the first boiler 3 to the dispensing head 5 and a second by-pass line 12 of the first boiler 3 hydraulically connecting the pump 2 to the dispensing head 5, naturally as well as a hydraulic connection line 13 for connecting the pump 2 to the first boiler 3.

The hydraulic line 13 may have a flow meter 15 and a pressure damper 16 downstream of the supply pump 2.

The hydraulic circuit further comprises a distribution valve means 14 switchable between a first connection configuration of the supply pump 2 to the first line 11 and a second connection configuration of the supply pump 2 to the second line 12.

The distribution valve means 14 is for example formed by a three-way solenoid valve, where an inlet way 14a is supplied by the supply pump 2, a first outlet way 14b supplies the first boiler 3 and a second outlet way 14c supplies the second hydraulic line 12.

Advantageously, the first line 11 is provided with a first non-return valve 17 calibrated at a first opening pressure and the second line 12 is provided with a second non-return valve 18 calibrated at a second opening pressure lower than the first opening pressure.

Each non-return valve 17, 18 comprises a shutter constrained by a guide and pushed by a spring against a seat: if the water pressure is insufficient to overcome the elastic force of the spring, the valve remains closed but if the water pressure is sufficient to overcome the force of the spring, the valve opens. The opening pressure difference can therefore be obtained by using springs with different rigidity for the first and the second non-return valve 17 and 18.

The supply pump 2 is configured to dispense water at a dispensing pressure comprised between 4 bar and 25 bar.

The first non-return valve 17 is calibrated with a first opening pressure comprised between 3 bar and 8 bar.

The second non-return valve 18 is calibrated with a second opening pressure comprised between 0.05 bar and 3 bar.

In particular, it has been found to be convenient to use a first non-return valve 17 calibrated with a first opening pressure comprised between 4 bar and 6 bar and a second non-return valve 18 calibrated with a second opening pressure comprised between 0.1 bar and 2.5 bar.

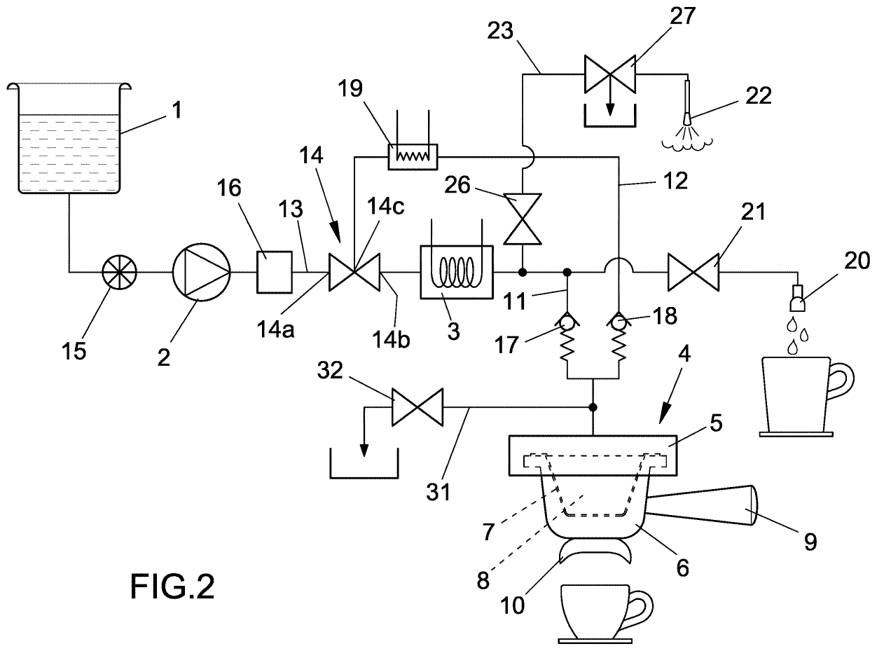

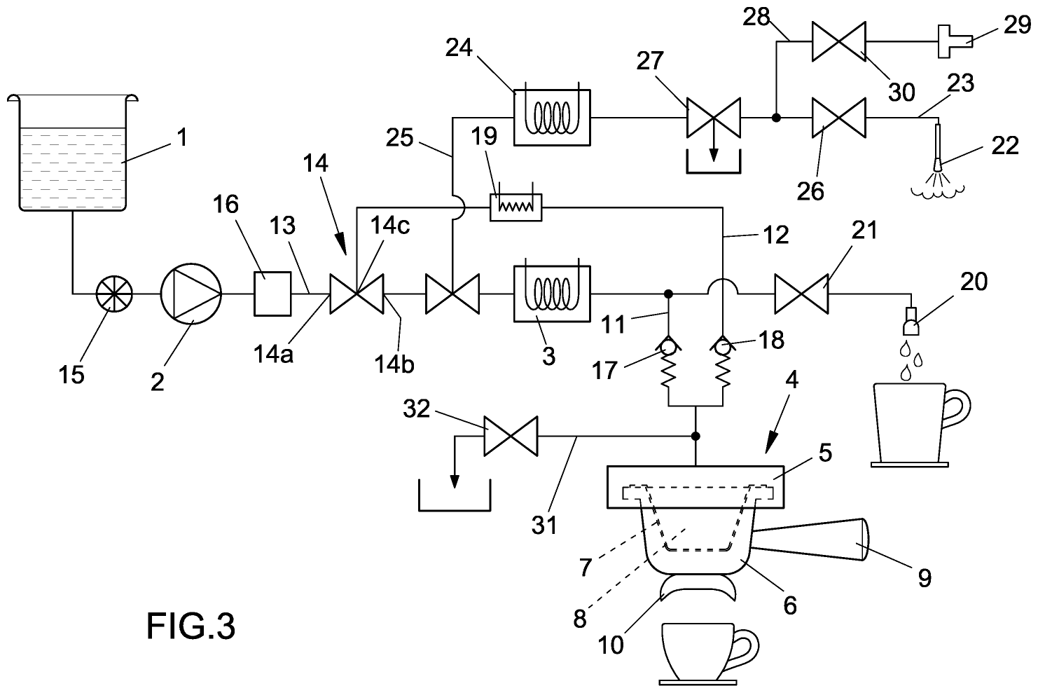

Advantageously, the hydraulic circuit along the second line 12 or alternatively upstream of said distribution valve means 14 can further have, as highlighted in the solutions illustrated in FIGS. 2 and 3, a thermal stabilizer 19 of the water coming from the water tank 1 and/or from the connection to the water supply.

The thermal stabilizer 19, formed for example by a low power boiler, is configured to stabilize the temperature of the water coming from the water tanks 1 and/or from the connection to a water supply in a range comprised between 25° C. and 35° C.

The filter holder 6 advantageously houses an espresso coffee filter 7.

The espresso coffee filter 7 is configured to maintain the pressure inside the brewing chamber 8 where the load of coffee powder is positioned.

The filter 7 comprises a tubular side wall 7a, a flange 7b which projects along the outer perimeter of the upper end of the side wall 7, and a bottom 7c, 7d, 7e.

The flange 7b in use is clamped between a support surface provided by the filter holder 6 and a hydraulic sealing gasket mounted in the dispensing head 5.

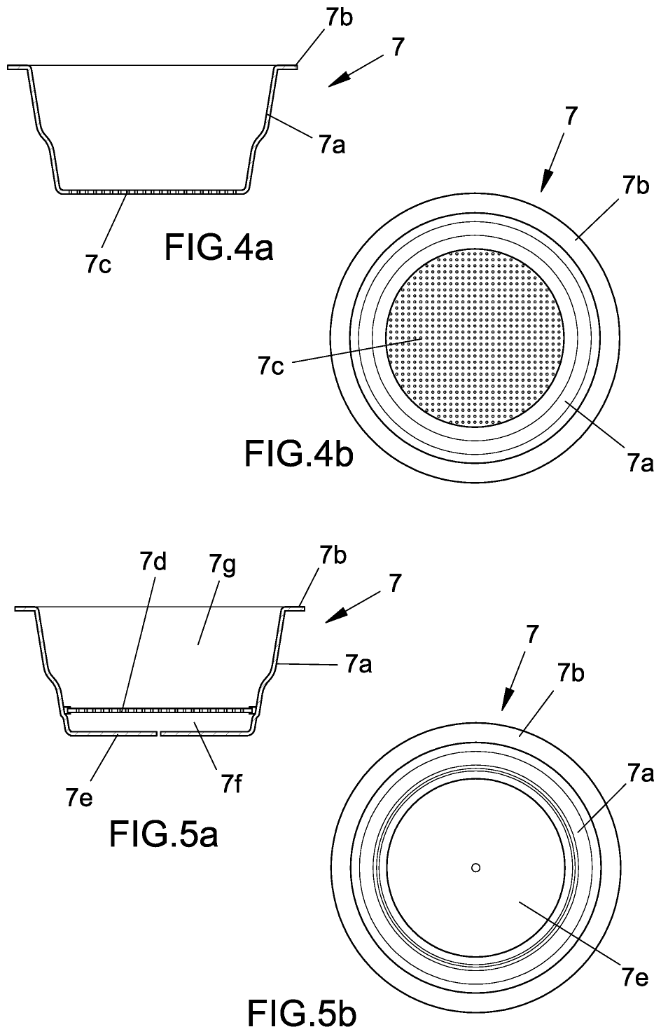

With reference to the solution illustrated in FIGS. 4a and 4b, the filter 7 has a bottom 7c with a single wall provided with a plurality of uniformly distributed holes.

With reference to the solution illustrated in FIGS. 5a and 5b, the filter 7 has a bottom having an inner wall 7d and an outer wall 7e delimiting with the inner wall 7d a second chamber 7f downstream of the chamber 7g where the load of coffee powder can be positioned.

The inner wall 7d of the bottom 7 has a plurality of uniformly distributed calibrated holes whereas the outer wall 7e has a single calibrated hole preferably centrally positioned.

The second chamber 7f also contributes to improving the emulsion of the coffee extract with air to give an even creamier effect to the coffee extract.

The hydraulic circuit of the coffee machine can comprise other components for adding other functions.

There may be a discharge line 31, provided with the relevant shut-off valve 32, in particular a solenoid valve, connected to the dispensing head 5, to the first line 11 downstream of the first non-return valve 17 and to the second line 12 downstream of the second non-return valve 18.

There may be a hot water dispenser 20 connected by means of a shut-off valve 21, in particular a solenoid valve, to the first boiler 3.

There may be a steam lance 22 and a steam line 23 connected to the first hydraulic line 11, as shown in FIG. 2, or to a second boiler 24 positioned along a third hydraulic line 25 connected to the supply pump 2 upstream of the first boiler 3, as shown in FIG. 3.

The steam line 23, if provided, has a shut-off valve 26, in particular a solenoid valve, and can have a discharge valve 27, in particular again a solenoid valve.

With reference to the solution illustrated in FIG. 3, a derivation 28 of the steam line 23 may be provided, connected to a steam dispenser 29 for heating and emulsifying milk contained in a jug not shown.

The derivation 28 of the steam line 23, if provided, is provided with a shut-off valve 30, in particular a solenoid valve.

The operation of the coffee machine is briefly as follows.

When a traditional espresso coffee extracted hot with a load of coffee powder contained in the filter 7 is to be prepared, the corresponding command is selected at an interface of the coffee machine with the user, and the electronic controller of the coffee machine switches the distribution valve means 14 into the first configuration, activates the first boiler 3 and the supply pump 2. The thermal stabilizer 19, if placed upstream of the distribution valve means 14, can be activated to collaborate with the heating provided by the first boiler 3.

When, instead, a cold extraction is to be performed with a load of coffee powder contained in the filter 7, the corresponding command is selected at the interface of the coffee machine with the user, and the electronic controller of the coffee machine switches the distribution valve means 14 into the second configuration, activates the thermal stabilizer 19 and the supply pump 2.

Given that the brewing pressure inside the brewing chamber 7g is determined by the type of coffee, particle size, dose, pressing of the powder in the filter and opening section of the holes positioned on the bottom of the filters, the working pressure P1 of the pump is not very high considering the modest opening pressure at which the second non-return valve 18 is calibrated.

Therefore, with respect to the hot espresso where instead the working pressure P2 of the pump is higher considering the modest opening pressure at which the non-return valve 17 is calibrated with all the other conditions unchanged, the result will always be P1<P2.

Considering the characteristic curve of the pump (particularly in the case m question the vibration pump) which envisages higher water flow rates as the working pressure of the pump decreases, it follows that with the described circuit, in the cold extraction the water flow rate Q1 will be higher than the hot one Q2, i.e., Q1>Q2.

This result provides a higher flow rate of coffee through the filter and the extracted coffee, bouncing on the bottom of the filter holder, will be able to incorporate air, increasing the creaminess of the beverage thus creating a natural “nitrogen infusing” effect, in a similar way to beverages in which nitrogen is actively added which in the coffee world is known as “nitro coffee”. The thermal stabilizer 19 guarantees that in the brewing chamber 8 the brewing temperature is stable and independent from the water temperature at the inlet from the tank 1 or from the water supply.

The cold extraction can take place in an ideal programmed temperature range preferably comprised between 25° C. and 35° C. so as to improve the cold extraction in terms of body and balance of the aromatic profile.

The cold extraction is further improved by the espresso coffee filter 7 configured especially to contain a dose of ground coffee with a particle size comparable with that of traditional espresso coffee extracted hot.

With the filter illustrated in FIGS. 4a and 4b it is preferable to use a coffee with finer grind to have a similar effect in terms of cream.

This filter 7 has calibrated holes to prevent the immediate venting of the pressure inside the brewing chamber 8 keeping it at suitable values preferably comprised in a range between 6 bar and 15 bar before letting the coffee extract out.

The user can thus consume a cold pure coffee extract at a temperature comprised between 25 and 35° C. or cool it by adding ice to the cup or cubes of a material suitable for cooling it without water being added to the coffee extraction, according to personal tastes with respect to the aromatic profile guaranteed by the extraction at high pressure associated with an extraction temperature stably comprised between 25 and 35° C.

The coffee machine as conceived herein is susceptible to many modifications and variations, all falling within the scope of the inventive concept; further, all the details are replaceable by technically equivalent elements.

In practice, the materials used, as well as the dimensions, can be any according to the needs and the state of the art.

1. A coffee machine comprising a water supply pump, a first water heating boiler, a brewing unit comprising a hot water dispensing head, a first hydraulic connection line for connecting said first boiler to said dispensing head, a second by-pass line of the first boiler, hydraulically connecting said pump to said dispensing head, a distribution valve means switchable between a first connection configuration of said supply pump to said first line and a second connection configuration of said supply pump to said second line wherein said first line is provided with a first non-return valve calibrated at a first opening pressure and said second line is provided with a second non-return valve calibrated at a second opening pressure lower than said first opening pressure.

2. The coffee machine according to claim 1, wherein said brewing unit comprises a filter holder housing a filter engageable with said dispensing head for delimiting a brewing chamber.

3. The coffee machine according to claim 1, wherein said supply pump is configured to dispense water at a dispensing pressure between 4 bar and 25 bar, said first non-return valve is calibrated with a first opening pressure comprised between 3 bar and 8 bar and said second non-return valve is calibrated with a second opening pressure between 0.05 bar and 3 bar.

4. The coffee machine according to claim 3, wherein said first non-return valve is calibrated with a first opening pressure between 4 bar and 6 bar and said second non-return valve is calibrated with a second opening pressure between 0.1 bar and 2.5 bar.

5. The coffee machine according to claim 1, further comprising a water tank and/or a connection to a water supply, and a thermal stabilizer along said second line or upstream of said distribution valve means.

6. The coffee machine according to claim 5, wherein said thermal stabilizer is configured to stabilize the temperature of water coming from said water tank and/or from said connection to a water supply in a range between 25° C. and 35° C.

7. The coffee machine according to any one of claim 2, wherein said filter holder houses an espresso coffee filter.

8. The coffee machine according to claim 7, wherein said espresso coffee filter is configured with holes calibrated to maintain a brewing pressure between 6 bar and 15 bar inside said brewing chamber.

9. The coffee machine according to claim 1, wherein said distribution valve means comprises a three-way solenoid valve.

10. The coffee machine according to claim 1, further comprising a steam lance and a steam line connected to said first hydraulic line or to a second boiler positioned along a third hydraulic line connected to said supply pump upstream of said first boiler.

11. A method for extracting coffee with a coffee machine according to claim 1, wherein a cold extraction is performed at a greater brewing rate than envisaged for cold extraction of espresso coffee through the switching of said distribution valve means to said second connection configuration.

12. The method for extracting coffee according to claim 11, wherein said first boiler is activated for a hot extraction of espresso coffee, and said thermal stabilizer is activated for the cold extraction of coffee.

13. The method for extracting coffee according to claim 12, wherein said thermal stabilizer is also activated for hot coffee extraction if it is placed upstream of said distribution valve means.
